(19) United States
(12) Patent Application Publication
(10) Pub. No.: US 2004/0049412 A1
(43) Pub. Date: Mar. 11, 2004

(54) Electronic commodities and automated ticket manager

(76) Inventor: Jeffrey P. Johnson, Sorrento, FL (US)

Correspondence Address: MANELLI DENISON & SELTER PLLC, 2000 M Street, N.W., 7th Floor, Washington, DC, 20036-3307, US

(21) Appl. No.: 10/237,683

(22) Filed: Sep. 10, 2002

(51) Int. Cl. G06F 17/60

(52) U.S. Cl. 705/5; 705/6

(57) ABSTRACT

The present invention provides the creation of a destination management and fulfillment service that consolidates existing ticketing and destination marketing systems in, e.g., the travel and leisure industry, into an automated electronic commodities manager and/or automated ticket manager. In a preferred embodiment, a network of automated ticketing devices (interactive unmanned kiosks) are deployed for on and off-property ticket sales and fulfillment, in addition to venue ticketing systems and automated sales channels, to provide product fulfillment remotely. The present invention facilitates LIVE inventory management and sales through to payment by and delivery to the end user. It also allows these functions to be monitored and reacted to in real-time, thus providing live inventory management, sales and marketing, financial processing and contract management.

### BACKGROUND OF THE INVENTION

1. Field of the Invention

The present invention relates to ticketing systems. More particularly, it relates to an electronic commodities service, networked venue core and remote ticketing systems.

2. Background

From the perspective of a travel professional, there is no automated system for acquisition of a variety of theme park and attraction tickets in the travel and tourism industry. A labor-intensive manual fulfillment process that is costly to the parks and venues currently meets this need. It involves licensing distribution partners like travel agents and hotel concierges to carry and maintain proprietary tickets.

Currently, vendors distribute hard inventory to both the public and to resellers of their products. This takes the form of tickets, vouchers, coupons, gifting, promotions, discounts, special entitlement packages, loyalty programs, and the like. Furthermore, valuable customer, reporting, and accounting data are either not collected or is exchanged (and in many cases lost) through cumbersome channels. Because most hard inventory is distributed via traditional channels, e.g. the U.S. Postal Service, there are massive resources in place to handle, control, and protect it. This is both costly and time consuming for all parties. Some inventory is lost or stolen and distribution opportunities are missed. To summarize, the problems with the status quo include:

1. Hard inventory handling is expensive and time consuming.

2. Valuable data is lost or not collected at all.

3. Data exchange is cumbersome.

4. The collected data is inefficient.

5. Hard inventory gets lost.

6. Hard inventory gets stolen.

7. Distribution opportunities are missed.

8. No universal way to exchange data between systems providers and distribution channels with capabilities to reach the end-user.

Current systems and methods relate only to ticket management software, and typically support only a single event and/or single time engagement. Conventional systems do not typically take reservations, assign seating, or manipulate entitlement inventories in a live environment. This makes other systems unsuitable for certain attractions such as theaters, which have multiple performances daily, and require assigned seating.

One conventional network of ticketing machines called VAST simply stores up a block of available tickets and sells from that stored up inventory. Thus, some outlets may sell out of tickets well before others, and available tickets may be left unsold in some outlets while other outlets may have a pent up demand for more tickets beyond those that were stored up. These systems do not sell in a truly live environment with all tickets available to all outlets. Moreover, these type systems typically cannot handle multi-event packages.

Currently, ticketing takes place at travel agencies like AAA and hoteliers like Fairfield. However, manual processes severely limit the financial reward incurred in the sale of these tickets due to salaries. Similarly a logistics difficulty occurs in tracking tickets, sales, revenues and ticket inventories. Additionally, theme parks have great difficulty fulfilling ticket sales in their mail and phone order channels.

Generally speaking, conventional manual ticketing systems are a logistics problem for both the venue and the distributor. For instance, issues of daily concern are the current status of ticket stock, accounting balances to discount or track theft, and/or sales reporting and analysis by channel, agent and region.

There is thus a need for an improved and automated ticket technique and apparatus.

### SUMMARY OF THE INVENTION

In accordance with the principles of the present invention, an automated ticketing system comprises a plurality of remote ticketing stations. A central database maintains an inventory for a plurality of different commodities. Each of the plurality of remote ticketing stations communicates with the central database to support sales of a purchased commodity. The commodity is provided at the time of purchase directly to a purchaser via one of the plurality of remote ticketing stations, wherein each of the plurality of remote ticketing stations has access to sell identical commodities maintained in the inventory. The remote ticketing stations validate only unsold commodities.

An automated commodities vendor in accordance with another aspect of the present invention comprises an automatic teller machine functionality, and a display adapted to visually display pictures of an urgent public nature.

A method of selling hard tickets to purchasers at remote locations in accordance with yet another aspect of the present invention comprises provisioning a plurality of remote ticketing stations. A central database is maintained including an inventory for a plurality of different commodities. Each of the plurality of remote ticketing stations communicates with the central database to support sales of a purchased commodity. The commodity is provided at the time of purchase directly to a purchaser via one of the plurality of remote ticketing stations, wherein each of the plurality of remote ticketing stations is provided access to sell identical commodities maintained in the inventory. The remote ticketing stations validate and encode only unsold commodities at the time of purchase.

### BRIEF DESCRIPTION OF THE DRAWINGS

Features and advantages of the present invention will become apparent to those skilled in the art from the following description with reference to the drawing, in which:

FIG. 1 shows an exemplary electronic ticket manager system, in accordance with the principles of the present invention.

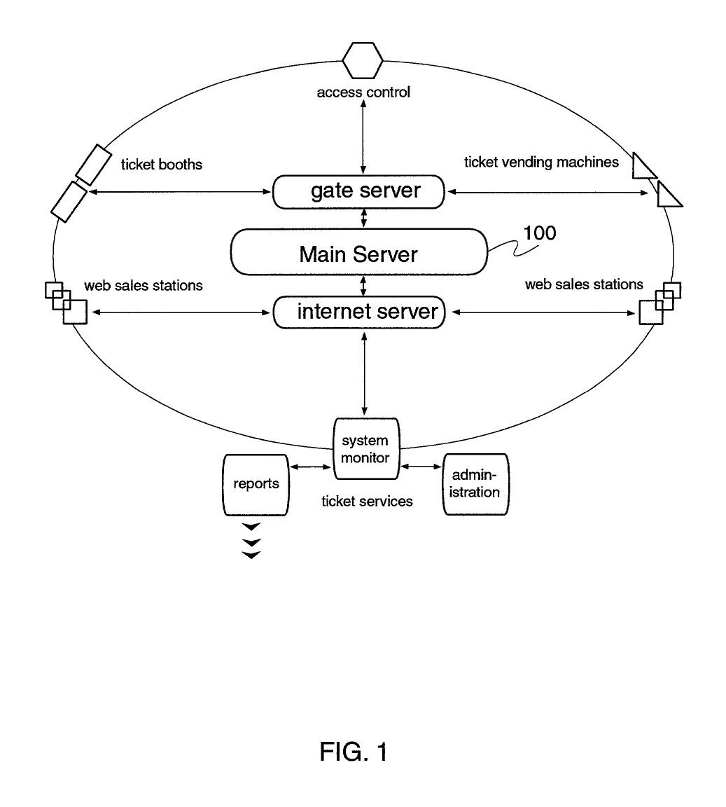

FIG. 2 shows an exemplary electronic commodities and automated ticket system, in accordance with the principles of the present invention.

FIG. 3 shows a diagram of an exemplary ceWeb e-commerce store front, a web portal using electronic commodities and automated ticket systems in accordance with the principles of the present invention.

FIG. 4 shows exemplary kiosk electronic commodities and automated ticket systems, in accordance with the principles of the present invention.

FIG. 5 shows an exemplary kiosk sales system combining both kiosk services and normal electronic commodities and automated ticket systems, in accordance with the principles of the present invention.

FIG. 6 shows a network diagram including an overview of exemplary on-site ticketing for attractions and venues, in accordance with the principles of the present invention.

FIGS. 7 to 10F describe an exemplary user interface implemented in an exemplary kiosk of an electronic commodities and automated ticket manager, in accordance with the principles of the present invention.

In particular, FIG. 7 shows an exemplary user interface and process, in accordance with the principles of the present invention.

FIGS. 8A to 8F show an exemplary user interface flow diagram, in accordance with the principles of the present invention.

FIGS. 9A to 9E show an exemplary user interface main flow diagram, in accordance with the principles of the present invention.

FIGS. 10A to 10F show an exemplary user interface ticketing flow diagram, in accordance with the principles of the present invention.

### DETAILED DESCRIPTION OF ILLUSTRATIVE EMBODIMENTS

The present invention provides the creation of a destination management and fulfillment service that consolidates existing ticketing and destination marketing systems in, e.g., the travel and leisure industry, into an automated electronic commodities manager and/or automated ticket manager. In a preferred embodiment, a network of automated ticketing devices (interactive unmanned kiosks) are deployed for on and off-property ticket sales and fulfillment, in addition to venue ticketing systems and automated sales channels. The present invention ties together the vendor (attraction) and the distributor (agent), and dispenses purchased tickets in a secure fashion.

While many systems enable the sale of products anywhere via the Internet, they generally fail to provide product fulfillment remotely. The present invention facilitates LIVE inventory management and sales through to payment by and delivery to the end user. It also allows these functions to be monitored and reacted to in real-time, thus providing live inventory management, sales and marketing data, financial processing and contract management/business rules.

Inventory management may be automatically managed and controlled, including procurement, storage and distribution. Inventory is preferably procured by managing virtual stock levels and by ensuring orders to vendors are processed in a timely manner. Inventory is preferably stored by holding electronic. Inventory is remotely distributed to a remote end user by distributing electronic products (e.g., theme park tickets, golf reservations, etc.) to a remote kiosk tied into a live, real-time system network. The product value is encoded onto hard collateral at the time of purchase.

It is important to note that the system handles an inventory of pre-defined, valuable electronic commodities that are a currency in themselves. This is different than a system that prints tickets from an allotment, such as in a movie theater. The value resides in the date itself and the ability of that data to remain a singular entitlement throughout its lifecycle.

The disclosed embodiment includes a sales and marketing module which preferably controls aspects such as advertising; product descriptions, pricing, promotions and placement; sales through wholesale channels; sales through retail channels; direct access to the consumer even through wholesale channels, thereby retaining a direct relationship with the end user; customer relationship management; and marketing data and reporting (e.g., measuring the results of marketing campaigns, product and/or price changes in real time.)

The disclosed embodiment also includes a financial processing module which preferably provides financial processing capabilities, enabling payment collection and the distribution of funds through aspects of the sales channel. This includes collecting payment from the end user; calculating and distributing funds to sales persons, retail agents, wholesalers and vendors; collecting, calculating and distributing taxes; and administering loyalty programs such as gifting rewards and use as a method of payment.

The disclosed embodiment further includes a contract management module which implements and controls contracts between vendors and their distribution and sales channels, preferably including wholesale and/or retail relationships. Desirably, the contract management module administers business rules between vendors and sellers. Vendors and sellers are then able to outsource the electronic management of contracts. Exemplary core functions include purchasing, stock control, invoicing, credit, accounts payable, accounts receivable, pricing, marketing collateral, incentives (e.g., spiffs), and discounts.

A ticketing core system provides improved security, tracking, automated sales channels and scalability. Preferably, software implementing the principles of the present invention provide an easy migration path from any of a variety of conventional core ticketing systems such as the VGS/OmniTicket Network.

Preferably, streaming XML programming language is used to effectively communicate with a wide array of remotely installed ticketing systems and delivery channels. Exemplary delivery channels include kiosks, and wireless terminals, as well as standard ticketing booths.

Preferably, the electronic commodities and automated ticket manager communicates with legacy systems and provides comprehensive reporting including data from the legacy systems.

The electronic commodities and automated ticket manager may also support a host of devices that assist the venue in ticket tracking. Ticketing machines in accordance with the principles of the present invention installed country-wide and/or internationally may sell tickets for various venues, and have the ability to report ticket sales to the electronic commodities and automated ticket manager network. The electronic commodities and automated ticket manager network in turn may accurately report the status of sales to each particular venue.

By way of example only, the electronic commodities and automated ticket manager network preferably may communicate with many types of devices, e.g., wireless ticketing units, card readers (for magnetically encoded tickets), radio frequency readers (for RF cards or RF wristbands), admission controls such as turnstiles, gates or entrance doors, traffic flow monitors, personal locator systems (e.g., for finding lost children), bar code readers, personal ID number systems, and/or banking network devices such as debit cards or credit cards.

The exemplary electronic commodities and automated ticket manager was developed in Java software programming language, and uses an appropriate database engine such as ORACLE™, SYBASE™, or INFORMIX™. The workstation applications are a Web Based Client, developed in Macromedia Flash, Actionscript, Java and JSP. The electronic commodities and automated ticket manager is built on a Java Corba Web Service Architecture. This architecture is fault tolerant and supports a wide variety of redundancies.

The new paradigm allows companies to securely distribute any form of electronic commodity imaginable and have it converted to hard inventory only at its final distribution point, the customer's hand. CEIRIS is able track the entire process, collect data from the source, and dynamically redistribute this data as a commodity in its own right.

With an instantaneous delivery mechanism at their disposal, businesses can focus all their efforts on communicating the value of their products, rather than expending significant numbers of resources to get information to a consumer and to deliver tickets into the consumer's hands.

The term user interface (UI) as used herein refers to the process a person physically interacts with while utilizing an electronic commodities and automated ticket manager, whether that be graphical, aural, or any combination that constitutes a “flow” through which a transaction is processed. Currently, these include PC systems, touch-screen systems, wireless systems, WAP systems, phone systems, World Wide Web systems, and combinations of these working in conjunction with one another.

The term client as used herein refers to the component(s) that directly support the UI and communicates with the back-end electronic commodities and automated ticket manager system.

EXtensible Markup Language (XML) is preferably used to pass meaningful electronic commerce information throughout the system. XML language also enables outside systems to communicate with the electronic commodities and automated ticket manager in an effective and open manner. Because the individual client applications use the standard XML (or other versions thereof) to communicate with the back-end, business partners can choose any desirable user interface mechanism. The client applications preferably deliver a uniform set of requests to the back-end, which processes and delivers them without the need to know anything special about the user interface world from which they originated.

Inside the client layer, the system architecture is a true listener model. The client listens for messages from a proxy server, and vice versa. This removes all logical bottlenecks and allows the system to process requests asynchronously.

An interface connector and the proxy server dynamically wrap requests from a client with a custom ID so that a Java Messenger Service (JMS) can deliver requests that are processed by the appropriate systems running concurrently.

Security is preferably tightly controlled. For instance, information is preferably encrypted and decrypted at both the client level and the proxy server level.

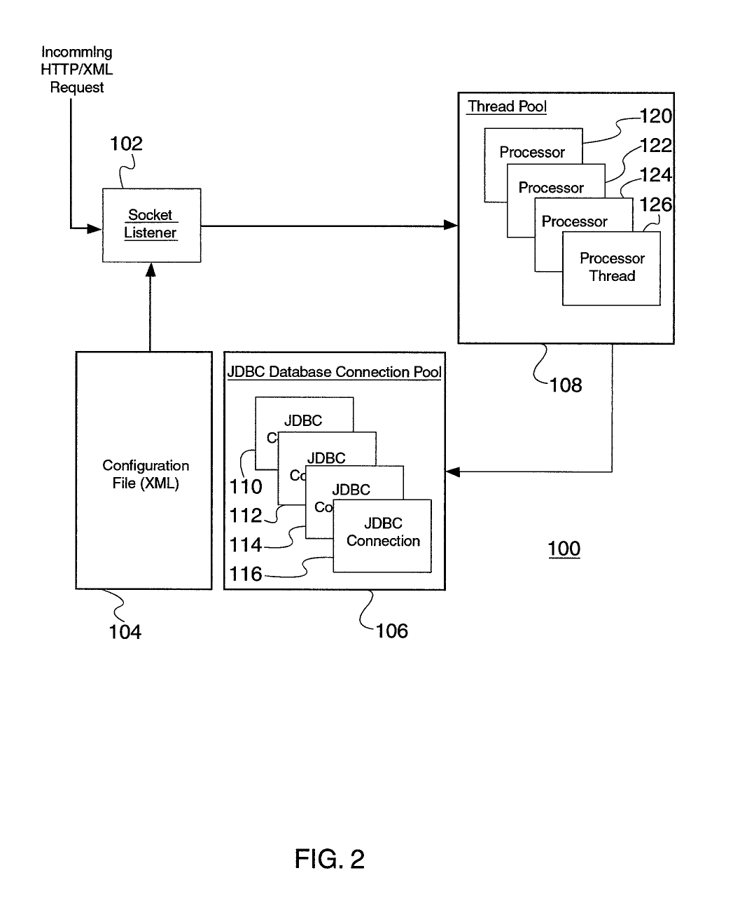

FIG. 2 shows an exemplary electronic commodities and automated ticket system, in accordance with the principles of the present invention.

In particular, as shown in FIG. 2, the exemplary electronic commodities and automated ticket system includes a socket listener 102, a thread pool 108, a configuration file for XML 104, and a JDBC database connection pool 106.

At startup, a electronic commodities and automated ticket system main thread loads the configuration file 104. It then uses this data to build the processor thread pool 108 and JDBC connection pool 106. This data is also accessible from the processor threads 120-126 to allow configurable behavior of the service being created.

The electronic commodities and automated ticket system main thread controls the socket listener class 102 that listens on a defined TCP/IP address and port for incoming HTTP connection requests.

The socket of the incoming request is passed from the socket listener 102 to the next available processor thread 120-126 in the thread pool 108. The next available processor 120-126 extracts the XML request from the input stream.

In the thread pool 108, the request type is determined from the input XML, and the request is processed. The response is sent back across the same socket as XML over HTTP.

From the thread pool 108, if the processor thread 120-126 needs access to a database, an existing connection is pulled from the JDBC pool. After its use, it is returned to the thread pool 108 for use by other processor threads 120-126.

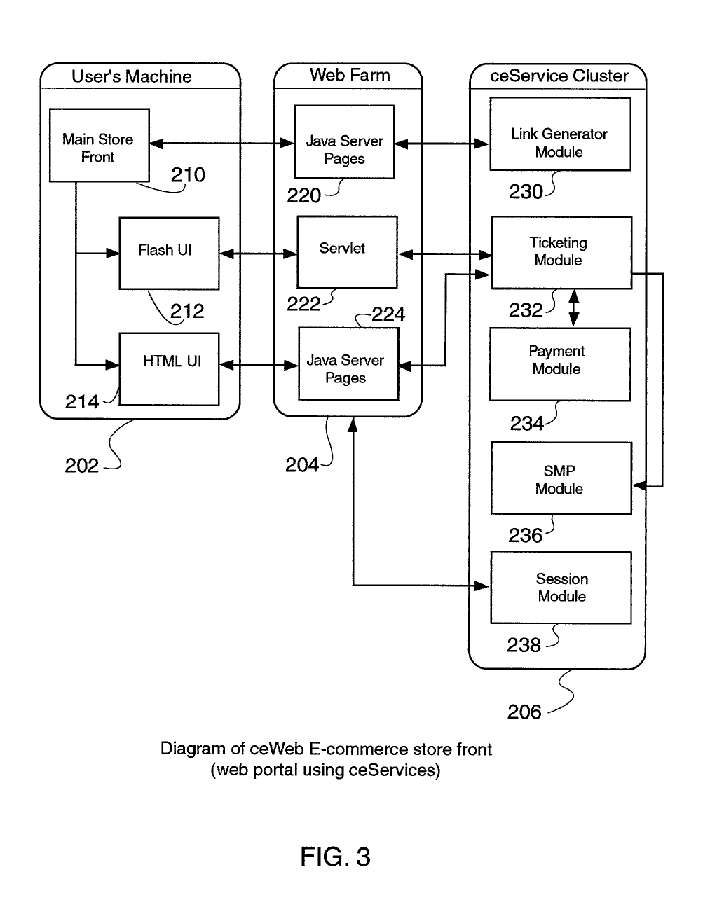

FIG. 3 shows a diagram of an exemplary e-commerce store front, a web portal using electronic commodities and automated ticket systems in accordance with the principles of the present invention.

In particular, as shown in FIG. 3, a store front includes a user's machine 202, a web farm 204, and a electronic commodities and automated ticket system cluster 206.

The user's machine 202 includes a main store front module 210, a Flash user interface 212, and an HTML user interface 214.

The main store front module 210 calls a link generator 230 via its generating JSP to help determine any special conditions based on the “merchant” universal resource locator (URL) parameter. This includes special graphics and login information. Ultimately this controls what items are displayed for sale in the online store.

In the Flash user interface 212, key data is passed from the main store front module 210 to the user interface to determine how to execute the login process which determines what the online store will display for its product offering.

The Flash user interface 212 communicates with the HTML user interface 214 using XML over HTTP to a servlet, which proxies requests to the desired electronic commodities and automated ticket systems. The HTML site is rendered to the user using JSPs which talk directly to the electronic commodities and automated ticket systems needed.

The web farm 204 includes Java server pages 220, a servlet 222, and Java server pages 224.

The electronic commodities and automated ticket system cluster 206 includes, e.g., a link generator 230, a ticketing module 232, a payment module 234, an SMP module 236, and a session module 238.

In the electronic commodities and automated ticket system cluster 206, the link generator 230 takes the “merchant” URL parameter, and converts it into a dataset used to control how the user interface renders itself, and how it logs into the ticketing system.

The ticketing module 232 is the business layer of the ticketing system. The ticketing module 232 supports functions that allow the user interface to display dynamic product content. The ticketing module 232 also executes purchase transactions and generates and emails a receipt to the customer.

The payment module 234 executes a credit card transaction. It is called by the ticketing module 232 during a purchase transaction.

The SMP module 236 is used to bring up the order details. Here it is being used by the ticketing module 232 to generate the information needed to create a receipt of the purchase transaction.

The session module 238 is used by the HTML user interface 214 to store session state information. This is because HTML is by nature a stateless environment. A user's shopping cart preferably exists in the session module 238.

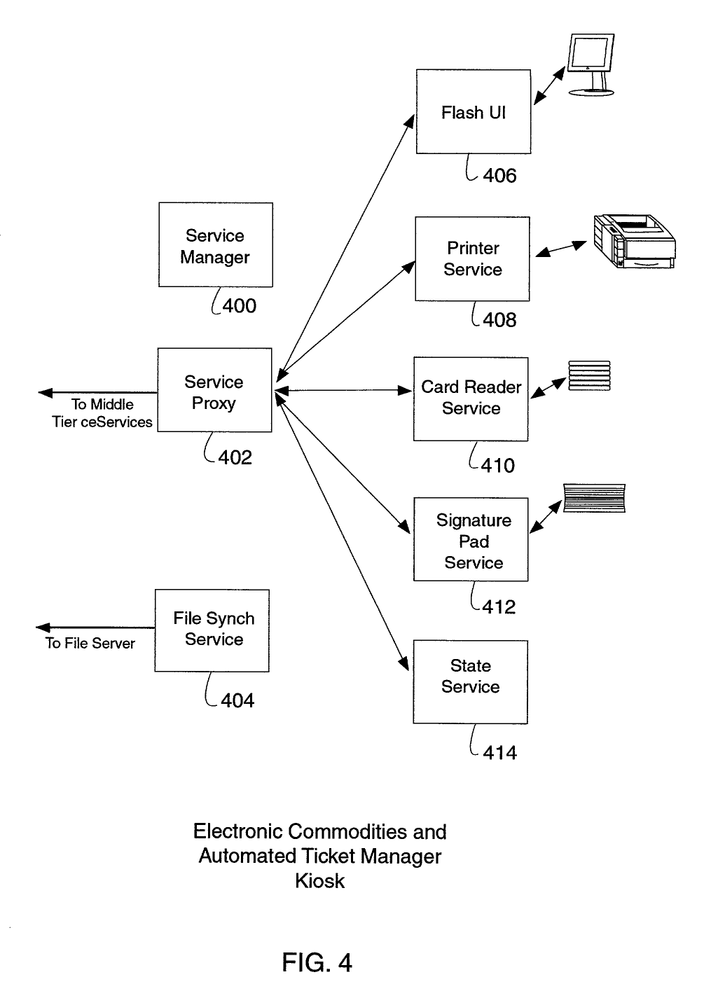

FIG. 4 shows exemplary kiosk electronic commodities and automated ticket systems, in accordance with the principles of the present invention.

In particular, FIG. 4 shows a kiosk or other element of an electronic commodities and automated ticket manager including a Flash user interface 406, a printer service 408, a card reader service 410, a signature pad service 412, and a state service 414 are all supported by a service proxy module 402 and a electronic commodities and automated ticket system service manager 400. A file synch service 404 is also preferably included.

The electronic commodities and automated ticket system service manager 400 controls the execution of other electronic commodities and automated ticket system processes. The electronic commodities and automated ticket system service manager 400 can start and stop elements of the electronic commodities and automated ticket system. Additionally, it can detect problems with other elements of the electronic commodities and automated ticket systems and restart them if necessary. The electronic commodities and automated ticket system service manager 400 generally runs as an NT service or a Unix Daemon, depending upon which operating system (OS) the kiosk may be operating under.

The service proxy module 402 routes incoming electronic commodities and automated ticket system requests to other kiosks or other elements of the electronic commodities and automated ticket system. This routing is based on a configuration file, allowing a central point of configuration for the kiosk's transaction configuration. This eases setup and maintenance tasks.

The file synch service 404 may be used to ensure that the kiosk has the latest file versions available, preferably on an automatic basis. The file synch service 404 uses MD5 checksums to match up its local files to those being served up by a file server, and downloads and deploys new files as they become available.

The Flash user interface 406 controls what gets displayed to the user. The data is retrieved from the middle tier electronic commodities and automated ticket systems using the service proxy module 402 to route requests. The Flash user interface 406 also sends requests to the various devices for things such as reading credit cards or printing tickets.

The printer service 408 is a electronic commodities and automated ticket system that executes print requests. It can control multiple printers with varying stocks. It can also handle redundant printer configurations with automatic failover if a printer fails.

The card reader service 410 is used to listen for credit card swipes, and when heard to transmit the relevant data to the requestor. The card reader service 410 parses the magnetic data and returns an XML representation of the data.

The signature pad service 412 captures a user's signature, and returns an XML representation of the data.

The state service 414 acts as a central repository for all state information about the machine. The various other services will broadcast state information periodically to the state service 414. The state information may be stored locally to a file, and also transmitted to a master repository.

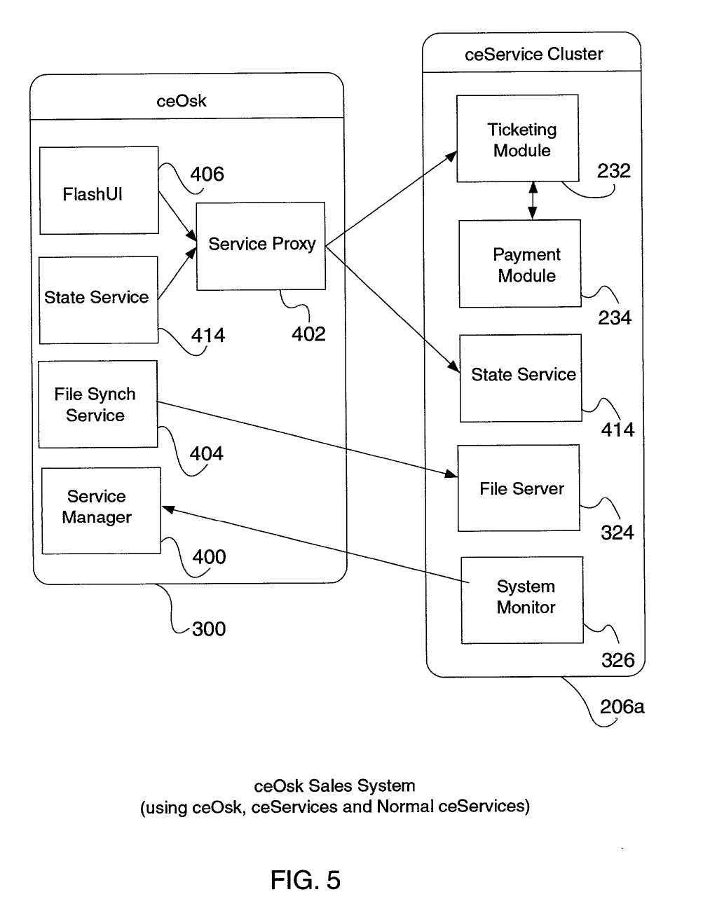

FIG. 5 shows an exemplary kiosk sales system combining both kiosk services 300 and normal electronic commodities and automated ticket systems 206a, in accordance with the principles of the present invention.

In particular, as shown in FIG. 5, a kiosk 300 includes a Flash user interface 406, a state service 414, a file synch service 404, and the service manager 400 of the electronic commodities and automated ticket manager, together with a service proxy 402.

The Flash user interface 406 communicates with the ticketing module 232 for both determining what content can be sold, and executing the sale itself.

The state service 414 in the kiosk 300 sends the latest state information to a master device in the electronic commodities and automated ticket system cluster, e.g., a master kiosk.

The file synch service 404 uses the file server 324 of the electronic commodities and automated ticket system cluster 206a to ensure that it has the latest versions of the files needed to run the local system.

The service manager 400 acts as a gateway for a system monitor 326 to remotely control its local kiosks of the electronic commodities and automated ticket systems.

Also as shown in FIG. 5, the electronic commodities and automated ticket system cluster 206a includes a ticketing module 232, a payment module 234, a state service 414, a file server 324, and a system monitor 326.

In the electronic commodities and automated ticket system cluster 206a, the ticketing module 232 and the payment module 234 are as described with respect to FIG. 4.

The state service module 414 in the electronic commodities and automated ticket system cluster 206a acts as a central repository of the state of all monitored kiosk tasks. It can preferably be configured to monitor the state information of each kiosk, detect problems and notify system personnel of any problems via email and/or SMS paging.

As described with respect to FIG. 4, the file server 324 of the electronic commodities and automated ticket system cluster 206a maintains the current production loadset. The file server 324 preferably also serves up the checksums and directory structures that should exist on the kiosk 300 in the field. If a particular kiosk 300 is not in synch, it can download necessary files from the file server 324.

The system monitor 326 is a central point of remote control over other electronic commodities and automated ticket systems. The system monitor 326 can communicate with remote electronic commodities and automated ticket system service managers 400 to perform actions such as remotely starting and stopping electronic commodities and automated ticket systems. It also can be used to view the performance metrics of remote electronic commodities and automated ticket systems.

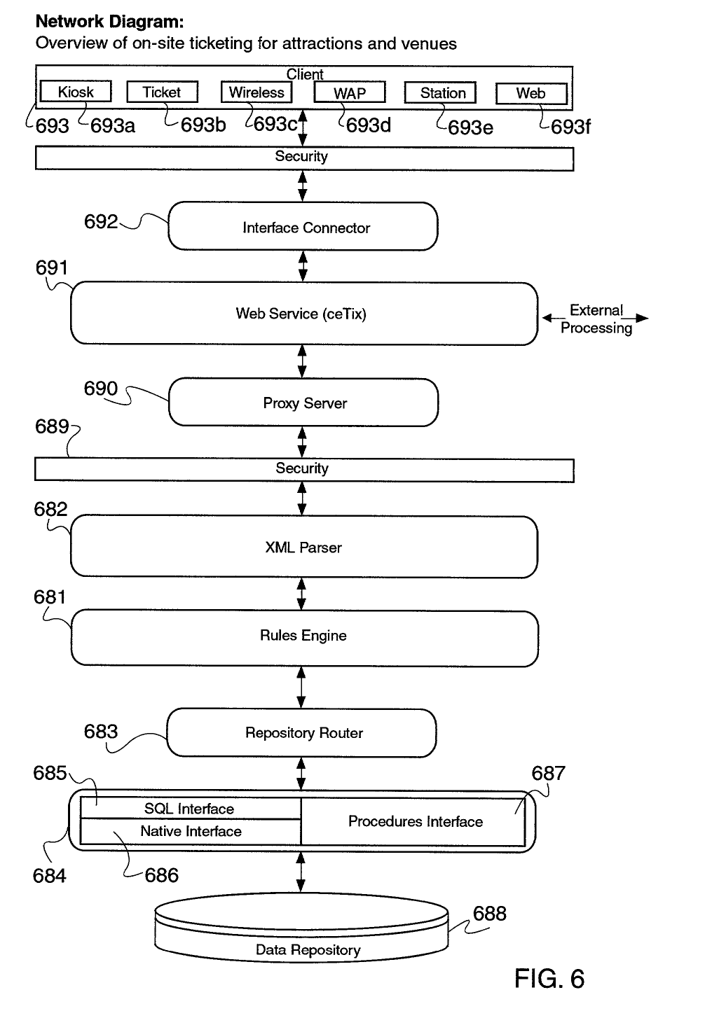

FIG. 6 shows a network diagram including an overview of exemplary on-site ticketing for attractions and venues, in accordance with the principles of the present invention.

In particular, FIG. 6 shows the individual components that are operating at each server. Each of these components has multiple instances running, and is cross-registered with one another. This enables them to handle large volumes of traffic, as well as makes them capable of transferring traffic to another component, in the event of a component failure.

Each server shown in FIG. 6 preferably runs a complete version of the electronic commodities and automated ticket manager, allowing each server to be focused on processing data specific to its site, while keeping the main server 100 informed of what transactions have occurred. The main responsibility of the main server 100 is to route information to and from all site servers.

An XML parser 682 strips out the vital information from an XML (or variant of XML) string. A rules engine 681 for the electronic commodities and automated ticket manager uses this information to determine what process must be employed to get a valid response. The rules engine 681 determines which request can be processed by which system and then passes the request to a repository router 683 or originates a request to be processed by an external system. The repository router 683 routes requests to the appropriate data interface or to the procedures interface 684. Requests originated by the rules engine 681 are passed to outside systems by Web Services 691. The SQL interface 685, native interfaces 686, and procedures interfaces 687 extract appropriate information from a data repository 688 and passes it back to the repository router 683. This is termed a “response”.

The rules engine 681 packages the response and passes it back up to the XML parser 682 which encodes and passes it back up through security 689. The proxy server 690 receives the response from security 689, identifies the wrapper, and passes it to the Web Service 691. Web Services 691 delivers the response to the interface connector 692 that unwraps the response and sends it to the appropriate client application 693. See FIG. 6.

The rules engine 681 is preferably able to create and manage an unlimited number of products regardless of their nature, unlimited relationships between vendors, distributors and consumers and unlimited number of business rules applied to any situation all with real-time reporting data.

The kiosks 693a shown in FIG. 6 may be desk or wall mounted touch-screen panel PCs (or free-standing PCs) allowing users to examine tourism destinations and events in a multimedia format. They are preferably well equipped to handle multimedia content, e.g., with an 18-inch touch screen to display graphics and the processing power to stream video content in the kiosk user interface. Travel agency kiosks may be configured with national and/or international destination content and locally installed kiosks are configured with local destination content. An intuitive interface guides customers quickly and clearly through the purchase process. After one experience using a kiosk, customers will feel comfortable using it again.

Touch-screen devices may be installed and operated inside kiosks to provide efficient self-service ticketing. They may be selected and configured for indoor or outdoor use. Purchase of tickets can be accomplished through both credit card and cash.

Kiosks configured to accept cash transactions can also be configured to additionally function as an automatic teller machine (ATM), thereby providing another source of income.

The station 693e shown in FIG. 6 is a graphic interface guide for on-site sale of tickets through point of sale (POS) stations. A constant flow of data in the live nature of the system provided by the electronic commodities and automated ticket manager lets agents know what is being sold on the spot, eliminating guesswork and driving sales.

Untethered ticketing handheld devices may be used as a wireless station 693c, e.g., to process credit card transactions. The wireless station 693c allows a sales agent to roam with a ticket vending station or kiosk in the palm of their hand. A menu-driven interface may be implemented to enable easy, fast remote ticketing at previously inaccessible locations.

A web interfaced station 693f or kiosk may be implemented to allow customers to purchase tickets over the web and pick them up through any of a number of devices in the electronic commodities and automated ticket manager network, e.g., at any kiosk, where they may be printed or encoded on the spot. This virtually eliminates fraud, and also avoids the loss of tickets in the mail.

The Electronic Commodities and Automated Ticket Manager can be used to track and push out information of any kind as a public service. For example, the pictures of missing children may be shown on units located in Rest Stops and Welcome Centers virtually immediately after the authorities upload them, e.g., within 30 seconds or so.

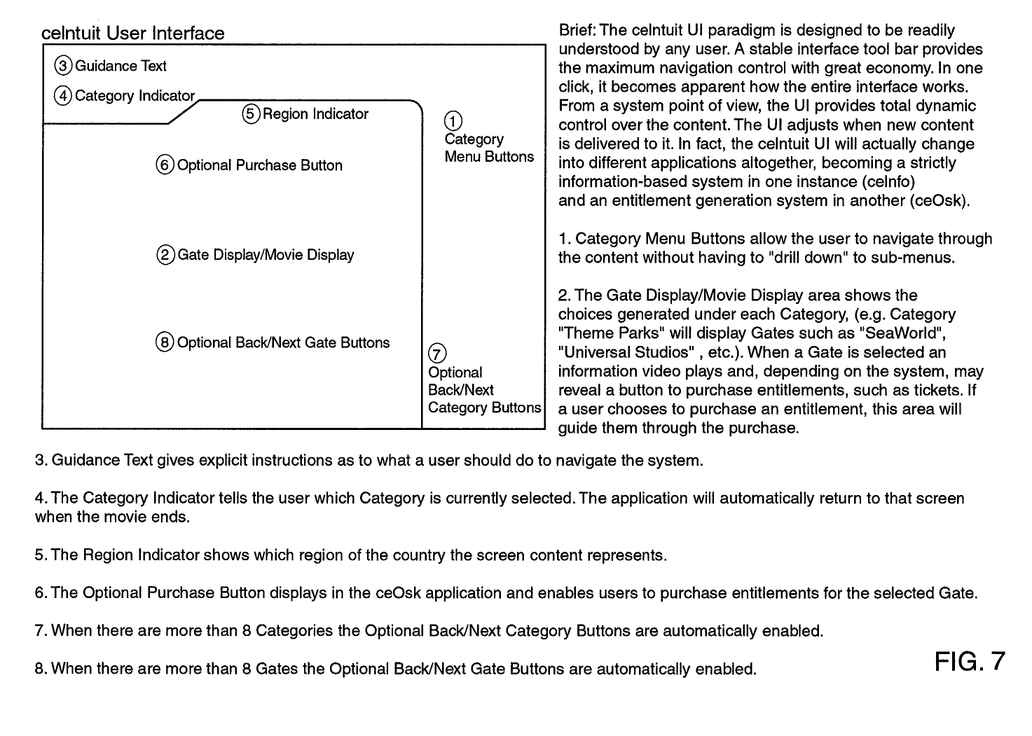

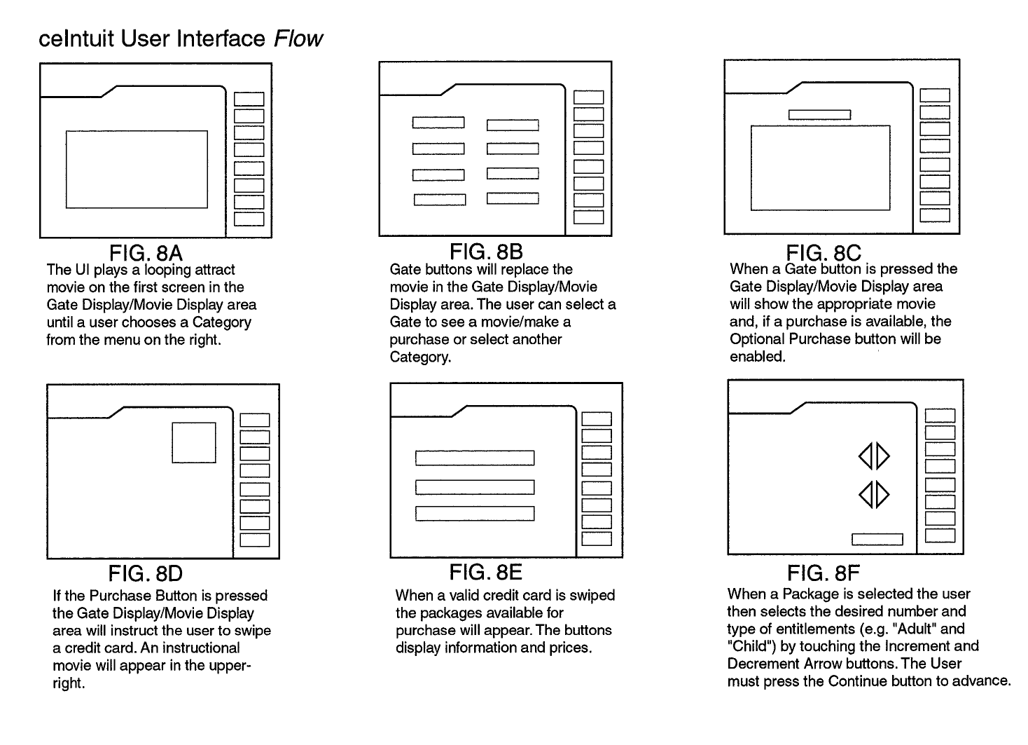

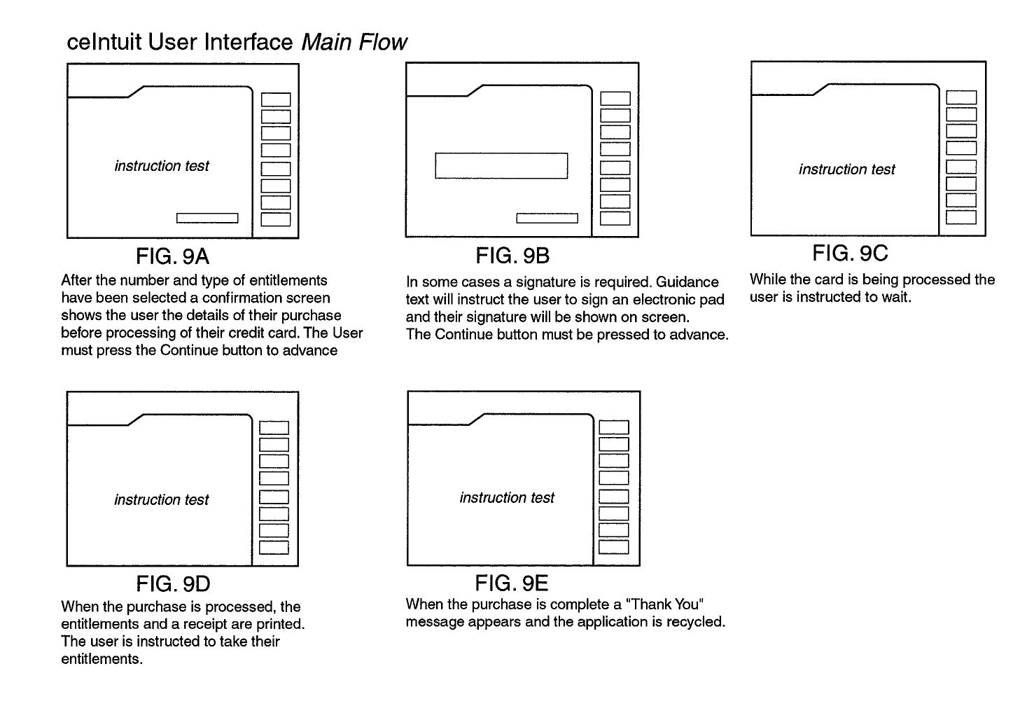

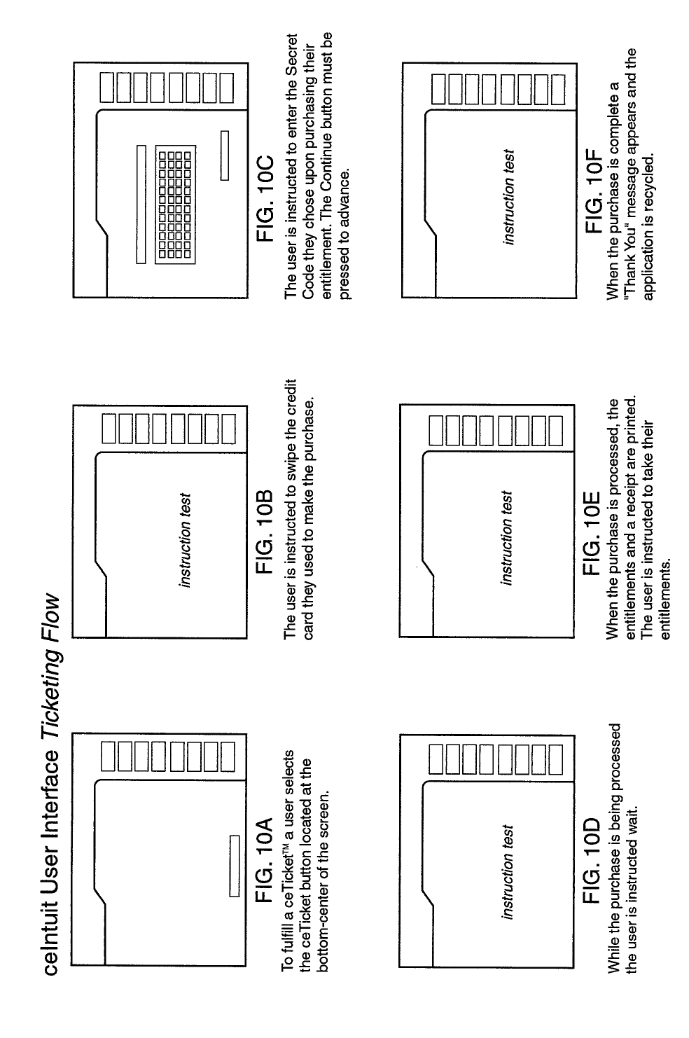

FIGS. 7 to 10F describe an exemplary user interface 406 implemented in an exemplary kiosk of an electronic commodities and automated ticket manager, in accordance with the principles of the present invention. It is to be understood that the specific user interface 406 described in FIGS. 7 to 10F is by way of example only. The present invention may make use of virtually any visual or auditory user interface.

The electronic commodities and automated ticket manager preferably includes interfaces to a wide array of remotely installed ticketing systems and delivery channels, whether proprietary or off-the-shelf, enabling business partners to take advantage of modern delivery channels such as ATMs, kiosks, and wireless terminals, as well as standard ticketing booths. When existing systems are too deeply rooted in out-dated or proprietary systems (e.g. in a ticketing operation), that system can remain in place by including an interface to an electronic commodities and automated ticketing system. The electronic commodities and automated ticket manager may also track ticketing.

As an example, assume that site #1 sold a ticket to site #2. In such an instance, site #1 would send this information to the main site. The main site would then determine that site #2 would need to be notified of this transaction, so that the ticket could be validated.

If a site goes offline, the data is preferably collected. Once the site is brought back online, the site would then exchange necessary data with the main site. One restriction that preferably applies during such outages is that the offline site would not sell tickets that would be valid, for a given period of time, for any other sites.

The main site has the responsibility of handling any additional load that might be created in the event of a site server failure. If a site server failure occurs, the main site continues with its transactions, and preferably the client workstations would not be made aware that anything had failed on the site server. Then, once the site server is brought back online, it would again take over control of those transactions.

The main site server is preferably the server that various ticket services would keep updated with the latest information, e.g., regarding venues, events and products.

The main site server preferably also provides data to a secondary database for reporting purposes. The secondary database is preferably more normalized, and is updated continually from the transaction components.

The electronic commodities and automated ticket manager preferably includes an open interface to allow existing, legacy applications that otherwise communicate with, e.g., a VGS Scheduler to easily communicate with the electronic commodities and automated ticket manager without requiring significant (if any) modifications.

Communications to a credit authorization server may be handled with a suitable interface.

Potential systems implementing an electronic commodities and automated ticket manager in accordance with the principles of the present invention include (but are in no way limited to): live on-line remote ticketing for multiple entitlement packages; live wireless ticketing for multiple entitlement packages; electronic live will call facility using kiosks and/or sales stations; and live assigned seating systems without the need to implement refresh technologies.

The present invention provides a 24/7/365 automation direct ticketing system having exciting multimedia content to engage the ticket buyer and explain visually the product being purchased. Automated channels such as the inventive ticket vending machine increase profitability of the ticketing operation. Moreover, all reporting and inventories are automated at a central location/corporation. If inventory is unavailable, ticket sales may be suspended in that respect without revenue earnings.

In accordance with the principles of the present invention, orders can be fulfilled by a client by visiting any nearby Media location including a vending machine.

While the invention has many uses, particular advantages are foreseen in markets including hotels and resorts, attractions such as museums, historical and natural wonders, or eco tours. Also, theme parks, cruise operators, in-flight ticketing and reservations, local, national and international tour operators, and transportation companies. Sporting events such as football, golf, and ski resorts are potential markets for an electronic commodities and automated ticket manager, as are arcades/family fun centers. Dining reservations can be made on the fly in a truly live environment as tables become available. Other markets include entertainment venues, charters, private airlines, movie theatres, event venues, performing arts, civic centers, convention centers, play houses, and financial services.

While the invention has been described with reference to the exemplary embodiments thereof, those skilled in the art will be able to make various modifications to the described embodiments of the invention without departing from the true spirit and scope of the invention.

What is claimed is:

1. An automated ticketing system, comprising:
a plurality of remote ticketing stations; and
a central database maintaining an inventory for a plurality of different commodities, each of said plurality of remote ticketing stations communicating with said central database to support sales of a purchased commodity, said commodity being provided at the time of purchase directly to a purchaser via one of said plurality of remote ticketing stations;
wherein each of said plurality of remote ticketing stations has access to sell identical commodities maintained in said inventory, said remote ticketing stations validating only unsold commodities.

2. The automated ticketing system according to claim 1, wherein:
said inventory includes tickets to any of a plurality of events.

3. The automated ticketing system according to claim 2, wherein said plurality of events in said inventory consist of:
entertainment venues; and
resorts.

4. The automated ticketing system according to claim 3, wherein said plurality of events in said inventory further consist of:
said inventory includes seating at a restaurant.

5. The automated ticketing system according to claim 1, wherein:
said plurality of events in said inventory include seating at a restaurant.

6. The automated ticketing system according to claim 1, wherein:
said plurality of remote ticketing stations are located in at least three separate states.

7. The automated ticketing system according to claim 1, wherein:
at least two of said plurality of remote ticketing stations are spread apart by at least 100 miles.

8. The automated ticketing system according to claim 1, wherein:
at least two of said plurality of remote ticketing stations are spread apart by a continent.

9. The automated ticketing system according to claim 1, wherein:
at least two of said plurality of remote ticketing stations are spread apart by at least 10 miles.

10. The automated ticketing system according to claim 9, wherein:
said plurality of remote ticketing stations are interconnected via an Internet.

11. The automated ticketing system according to claim 9, wherein:
said plurality of remote ticketing stations are interconnected via a telecommunications network.

12. The automated ticketing system according to claim 1, wherein:
at least one of said plurality of remote ticketing stations is a kiosk.

13. The automated ticketing system according to claim 1, wherein:
a purchaser of a ticket as a commodity using said automated ticketing system receives an actual, hard ticket from one of said sales stations.

14. The automated ticketing system according to claim 1, wherein:
said automated ticketing system includes an interface to accept cash as payment for said commodity.

15. The automated ticketing system according to claim 1, wherein:
said automated ticketing system includes a deposit and cash withdrawal interface to provide automatic teller machine (ATM) functionality.

16. The automated ticketing system according to claim 1, wherein:
said automated ticketing system includes an interface to dispense cash.

17. The automated ticketing system according to claim 1, wherein:
said automated ticketing system includes an interface to accept credit card payment for said commodity.

18. The automated ticketing system according to claim 1, wherein:
said commodity is an entrance ticket.

19. The automated ticketing system according to claim 1, further comprising:
a secondary database for reporting purposes.

20. The automated ticketing system according to claim 1, further comprising:
a display adapted to display pictures of an urgent public nature.

21. The automated ticketing system according to claim 1, wherein:
said pictures of an urgent public nature include a picture of a missing child.

22. An automated commodities vendor, comprising:
an automatic teller machine functionality; and
a display adapted to visually display pictures of an urgent public nature.

23. The automated commodities vendor according to claim 22, wherein:
said displayed pictures include at least one of a missing child.

24. The automated commodities vendor according to claim 22, further comprising:
an automated ticketing manager to dispense tickets to a purchaser at said automated commodities vendor.

25. The automated commodities vendor according to claim 24, wherein:
said automated commodities vendor sells tickets to events maintained remotely in a database accessed by a plurality of automated commodities vendors, each ticket maintained as unsold in a database of said automated commodities vendor being equally accessible for sale by any automated commodities vendor.

26. A method of selling hard tickets to purchasers at remote locations, comprising:
provisioning a plurality of remote ticketing stations; and
maintaining a central database including an inventory for a plurality of different commodities, each of said plurality of remote ticketing stations communicating with said central database to support sales of a purchased commodity, said commodity being provided at the time of purchase directly to a purchaser via one of said plurality of remote ticketing stations;
wherein each of said plurality of remote ticketing stations is provided access to sell identical commodities maintained in said inventory, said remote ticketing stations validating only unsold commodities.

27. The method of selling hard tickets to purchasers at remote locations according to claim 26, wherein:
said commodity is a ticket to an event.

28. The method of selling hard tickets to purchasers at remote locations according to claim 26, wherein:
said commodity is an entry ticket.

29. Apparatus for selling hard tickets to purchasers at remote locations, comprising:
means for provisioning a plurality of remote ticketing stations; and
means for maintaining a central database including an inventory for a plurality of different commodities, each of said plurality of remote ticketing stations communicating with said central database to support sales of a purchased commodity, said commodity being provided at the time of purchase directly to a purchaser via one of said plurality of remote ticketing stations;
wherein each of said plurality of remote ticketing stations is provided access to sell identical commodities maintained in said inventory, said remote ticketing stations validating only unsold commodities.

30. The apparatus for selling hard tickets to purchasers at remote locations according to claim 29, wherein:
said commodity is a ticket to an event.

31. The apparatus for selling hard tickets to purchasers at remote locations according to claim 29, wherein:
said commodity is an entry ticket.
